(19) United States
(12) Patent Application Publication
(10) Pub. No.: US 2017/0056147 A1
(43) Pub. Date: Mar. 2, 2017

(54) ORAL HYGIENE SYSTEMS AND METHODS

(71) Applicants: Ramtin Khaef, Laguna Beach, CA (US); Amin Khaef, Laguna Beach, CA (US)

(72) Inventors: Ramtin Khaef, Laguna Beach, CA (US); Amin Khaef, Laguna Beach, CA (US)

(21) Appl. No.: 15/250,285

(22) Filed: Aug. 29, 2016

Related U.S. Application Data
(60) Provisional application No. 62/211,754, filed on Aug. 29, 2015.

(51) Int. Cl. A61C 17/22; A46B 5/00; A61C 17/34; A46B 9/04

(52) U.S. Cl. CPC A61C 17/222; A46B 9/04; A46B 5/0012; A46B 5/0095; A46B 5/0033; A61C 17/3454

(57) ABSTRACT

Apparatus, systems, and methods are disclosed for improved oral hygiene with reduced cleaning time required. The systems, methods, and apparatus disclosed in accordance with embodiments of the present invention comprises an attachment brush head that when attached to existing powered toothbrushes is capable of cleaning all tooth surfaces of upper and lower teeth simultaneously in compliance with effective brushing technique. In addition, the system and apparatus disclosed in accordance with embodiments of the present invention provides adjustable bristle angle and pressure in addition to adjustable brush head spacing, to avoid damage from excessive pressure to soft tissue, while ensuring sufficient bristle pressure for effective cleaning even with varying tooth thickness.

### CROSSREFERENCE TO RELATED APPLICATIONS

This application claims the benefit of U.S. Provisional Application No. 62/211,754, filed Aug. 29, 2015.

### BACKGROUND OF THE INVENTION

The present invention relates to oral hygiene in general, and more particularly, to systems, methods, and apparatus useful for improved oral hygiene with less time required.

In the United States over half the population is missing teeth, and poor oral hygiene is a large factor contributing to this problem. As time goes by, life expectancy is projected to increase, with commensurate increased risk of disease and health problems due to extended exposure to poor dental hygiene. Dental professionals recommend brushing for at least two minutes for effective oral hygiene, however, research shows the average person only spends 68 seconds when brushing their teeth. In view of this, it would be desirable to have a toothbrush head that minimizes brushing time to be just as effective as brushing for the recommended time with prior art methods, in less than the period of time that research shows the average person is willing to brush their teeth.

Currently there are a number of attempted solutions for making effective oral hygiene faster. Some of these attempted solutions brush all sides of the tooth surfaces at the same time, but fail to meet the industry need of having adjustable heads that account for different sized teeth. Other attempted solutions include using a specific motor with a reciprocating motion (back and forth motion), but these fail to meet the industry need of using a Modified Bass Technique of brushing up and down to obtain optimal oral hygiene. Other attempted solutions involve using sonic or ultrasonic movement (up and down movement) to perform optimal brushing but these attempted solutions fail, because they still require at least 2 minutes of brushing for effective oral hygiene, as their heads only brush one tooth surface at a time. Other attempted solutions involve using sonic or ultrasonic movement with a minimum of an entire arch, which would make it more of a mouthpiece than a toothbrush; however these attempted solutions fail to meet the industry needs of having a toothbrush head that is easily cleanable, as well as properly fitting the teeth of most users, since each patient arch may be of different sizes; thus, this would not be a one size fits all solution to optimally clean all teeth evenly. All of these solutions fail to meet the needs of the industry because they all require purchasing an additional electric toothbrush that will work with that specific head. Studies have shown that consumers generally do not have more than one type of electric toothbrush and will typically retain this electric toothbrush while only replacing the heads. These attempted solutions fail to meet the industry needs because the consumer already has existing electric oral care products that need improvement in reducing the time required for effective oral hygiene. All these attempted solutions fail to meet the needs of the industry, as consumers are generally not spending enough time brushing, leading to ineffective oral hygiene. In addition, 72% of the population reports they do not floss, however, they do brush.

Dental practitioners have developed many brushing techniques for patients through clinical research directed to preventing and controlling disease and improving oral hygiene. Several brushing techniques are wellknown and often recommended for effective oral hygiene, depending on the ability of the patient to learn and practice the technique, in addition to a willingness on the part of the patient to spend the additional brushing time required by these techniques when the use of a prior art toothbrush is contemplated. The available brushing techniques that are among those recommended by dental practitioners for effective oral hygiene can be grouped into two broad categories, one category including brushing techniques characterized by vibratory motion, and the other category including brushing techniques characterized by vertical sweeping motion. Brushing techniques characterized by vibratory motion include the Bass, and Stillman's brushing techniques. Brushing techniques characterized by vertical sweeping motion include the Rolling Stroke, Modified Bass, and Modified Stillman's. The most recommended techniques for brushing, based on cleaning performance, include the Bass, Stillman's, and Rolling Stroke techniques. The Rolling Stroke technique is often recommended in addition to or in combination with the Bass or Stillman's technique, where the Rolling Stroke motion is applied after the primary technique to yield a Modified Bass or Modified Stillman's technique. These recommended brushing techniques share common position and similar motion components, and all recommended techniques present problems to a prior art toothbrush.

The common features, critical for effective cleaning, of the Bass, and Stillman's techniques include positioning the bristles to a fortyfive degree angle to the long axis of tooth, and continuous bristle contact with the full tooth from root to biting surface with brushing motion cleaning the entire tooth. The Bass, and Stillman's brushing techniques differ slightly; while the Bass technique includes bristle contact into the Gingival Sulcus with vertical motion for prevention of periodontal disease, Stillman's technique uses backandforth horizontal movement with light pressure in the Gingival area, with the bristles not entering the Gingival Sulcus, for use in cases of Gingival Recession. The modified versions of the recommended techniques follow each iteration of the technique with a Rolling Stroke, comprising a vertical, or sweepingdown, brushing motion, beginning from the roots of the teeth to the occlusal or biting surface of the teeth.

The recommended brushing techniques described herein are known for effective oral hygiene performance, and yet have the disadvantage, when practiced with a prior art toothbrush, of requiring a patient to practice and learn the technique, possibly under supervision, in order for a patient to be able to perform the technique correctly as recommended by their dental practitioner. In addition, the recommended brushing techniques, when attempted with a prior art toothbrush, are time consuming, and may require more time than most patients are willing to spend brushing their teeth. For example, the modified Stillman's technique, while effective, can be complicated and time consuming; to perform the Modified Stillman's technique, a patient places the bristles over the roots (or cervical part) of the teeth and gingiva, with bristles at a fortyfive degree angle to a long axis of teeth; the patient then brushes in a horizontal backand forth motion for several seconds, followed by the rolling stroke; the toothbrush is then moved to another area of the mouth, and the technique is repeated, until all the teeth are cleaned.

Effectively performing recommended brushing techniques using prior art toothbrushes present dental patients with multiple problems including technique sensitivity and increased brushing time. In particular, positioning bristles at a recommended forty five degree angle to a long axis of a tooth may be difficult, and patients may not be able to maintain a recommended bristle angle with respect to a long axis of teeth as a prior art toothbrush is moved throughout the mouth to clean all the teeth. Embodiments of the present invention solve the problems of positioning and maintaining the bristle angle with respect to a long axis of teeth with the adjustable bristle angle and spacing, and angle and spacing locking, of embodiments of the present invention, which enables a patient to adjust bristle angle as recommended for the particular technique they are performing, and have that bristle angle maintained throughout the mouth for effective cleaning of all teeth. In addition, adjusting and maintaining pressure against teeth and gums is essential for correct performance of recommended brushing techniques, however when a prior art toothbrush is used, a patient may have difficulty using or maintaining correct bristle pressure as a prior art toothbrush is moved throughout the mouth. Recall that the Bass and Modified Bass techniques require bristle contact into the Gingival Sulcus, which requires more bristle pressure, and requires that the increased bristle pressure is applied consistently throughout the mouth as the brush is moved from tooth to tooth; this is difficult to learn and practice with a prior art conventional toothbrush; in addition, because teeth vary in width, even a prior art toothbrush that hugs all surfaces of the teeth can not maintain constant bristle pressure throughout the mouth for correct practice of these techniques. Embodiments of the present invention solve the problems of adjusting and maintaining bristle pressure for effective cleaning with tension stabilization of bristle pressure, which enables a patient to adjust bristle pressure according to their preferred technique, whether requiring more bristle pressure so that the bristles enter the gingival sulcus as in Bass technique or variations thereof, or, perhaps requiring less bristle pressure to only engage the gingival surface, as in Stillman's technique or variations thereof; in addition, the tension stabilization of bristle pressure of embodiments of the present invention serves to automatically maintain the selected bristle pressure as tooth width varies throughout the patient's mouth, to enable the patient to consistently practice the technique recommended by their practitioner.

Prior art toothbrushes include: conventional toothbrushes comprising one or more fixed brush head attached to a handle that attempts to clean one surface of teeth at a time, and toothbrushes with either multiple heads or wraparound heads that attempt to clean multiple surfaces of teeth at the same time. Although toothbrushes having multiple heads or wraparound heads do exist in the prior art, these toothbrushes encounter a problem in effectively and correctly performing recommended brushing techniques such as Bass, Stillman's, and their variations. The prior art toothbrushes that attempt to clean multiple surfaces of teeth at the same time with wraparound brush heads may not be adjustable to the correct brush head angle, spacing, and bristle pressure for correct performance of a recommended brushing technique. As disclosed herein, bristle angle, bristle contact, and bristle pressure are essential components of recommended brushing techniques such as Bass and Stillman's techniques. For example, both Bass and Stillman's technique require a fortyfive degree angle of the bristles to the long axis of a tooth, however the Bass technique requires greater bristle pressure than Stillman's technique, because correct performance of the Bass technique requires the bristles to enter the Gingival Sulcus. In contrast, Stillman's technique is indicated for patients already having gingival recession, and requires less bristle pressure, so that the bristles do not enter the Gingival Sulcus, but rather only contact the gingival surface. Further differences in the Bass and Stillman's techniques include that the Bass technique requires vertical motion, while Stillman's technique requires a horizontal motion. Prior art toothbrushes can not adapt to the correct performance of these techniques while cleaning all teeth surfaces at the same time. Embodiments of the present invention perform the critical elements of the recommended brushing techniques at the same time for all tooth surfaces. Embodiments of the present invention include adjustable brush head spacing, adjustable bristle angle, adjustable bristle pressure, and automatic bristle pressure compensation for variation in tooth width, in a toothbrush that cleans all surfaces of the teeth at the same time, with adjustable spacing to maintain bristle contact with all tooth surfaces, adjustable angle in accordance with the recommended angle prescribed, in addition to continuous bristle pressure compensation to maintain contact with the teeth for consistent cleaning of tooth and gum areas.

Further embodiments of the present invention may include a plurality of drive engagement modes providing a plurality of motion types selectable by a user, enabling a patient to select a vertical brushing motion to perform a Bass technique, or a horizontal brushing motion to perform a Stillman technique. Still further embodiments of the present invention may include a drive engagement having automatically alternating modes, which may operate in a vertical brushing motion for a first period of time, and then operate in a horizontal brushing motion for a second period of time, thus enabling a user to perform a combination technique such as Stillman's technique, which combines several seconds of a horizontal brushing motion with a rollstroke, where the rollstroke comprises a technique component added to techniques such as Bass or Stillman to yield the modified technique. Still further embodiments of the present invention may provide combinations of bristle pressure adjustment and motion type; in a nonlimiting example, to configure for a Modified Bass technique, a user would select vertical brushing motion and higher bristle pressure so that the bristles enter the Gingival Sulcus; in a further nonlimiting example, to configure for a Stillman's technique, a user would select a horizontal motion and lower bristle pressure so that the bristles do not enter the Gingival Sulcus; in a still further nonlimiting example, to configure for a Modified Stillman's technique, a user would select vertical plus horizontal motion (a few seconds of vertical motion followed by a few seconds horizontal motion) and lower bristle pressure.

Although regarded as effective, using recommended brushing techniques with a prior art toothbrush may present a patient with several challenges. Techniques such as Modified Bass and Modified Stillman's Techniques are more mechanically complex than other brushing techniques, requiring a greater level of manual dexterity and practice to effectively perform. In view of this, these techniques may be recommended for adults with higher levels of manual dexterity, and are not as often recommended for children or adults with less manual dexterity, including e.g. those with arthritis, other motor impairment, or neurodegenerative disease, which may interfere with the patient's ability to learn and apply the more difficult technique; however, through use of embodiments of the present invention, more effective oral hygiene with reduced time may be available even to patient's having impaired manual or cognitive performance.

The variation in tooth size within the mouth of one user, between large back teeth and smaller front teeth can be substantial. The average mandibular central incisor only has a bucco (facial)lingual width of 6 mm, whereas the average first molar has an average width of 11 mm, which is almost a 50% difference in width. The normal variation in thickness and size from tooth to tooth, both between teeth in a single patient, and between different patients, presents a problem to toothbrush heads that attempt to maintain bristle contact with teeth and to maintain bristle pressure against teeth for effective cleaning. In view of this, it would be desirable to have an adjustment to compensate for tooth and mouth size differences across user's of different sizes (for example, a smalltoothed individual vs. a largertoothed individual), to provide consistent bristle contact and pressure with teeth of varying size and thickness. In addition, it would also be desirable to have a universal brush head attachment, to maximize compatibility to existing brushes and to enable a greater number of the general population to have access to improved oral hygiene as provided by embodiments of the present invention, as well as minimize the number of packaging types for product sale.

It would be desirable if a toothbrush head, which can accomplish these objectives, can perform better cleaning, while working as an attachment to existing electric toothbrush types on the market. It would also be desirable to have an adjustment to account for the variation between individual dentition size, as in the variation in tooth size between large back teeth and smaller front teeth, to provide effective cleaning throughout the mouth, independent of tooth size.

In view of the foregoing, there exists a need in the art of oral hygiene for a faster, more efficient, adjustable, and universally attachable toothbrush head, and which assists even dental patients having limited manual dexterity in effectively performing a recommended brushing technique, even in areas of the mouth for which a recommended brushing technique may be difficult, for more effective oral hygiene leading to improved health outcomes in general.

### BRIEF SUMMARY OF INVENTION

Embodiments of the present invention overcome the challenges inherent in learning and applying recommended brushing techniques, even for patients with impaired manual dexterity, and provide an effective technique with a minimum of manual dexterity required by the patient. In addition, the recommended techniques are available, through embodiments of the present invention, to children who might be too young to learn or effectively perform a recommended brushing technique, providing more effective cleaning at a younger age and establishing an early habit of effective oral hygiene.

Some recommended techniques, although effective, may be difficult to apply in all areas of the mouth with a prior art toothbrush. In a nonlimiting example, the Modified Bass Technique, when performed correctly, effectively cleans most tooth surfaces, however some dental practitioners identify areas of the mouth which may be difficult to reach with a toothbrush when attempting the Modified Bass Technique. In particular, the region of the mouth which comprise the surfaces of the front teeth that face the interior of the mouth, may be difficult to reach with a prior art toothbrush while attempting the Modified Bass Technique. In view of this, some dental practitioners recommend using a technique different from the Modified Bass technique for areas difficult to reach with a prior art toothbrush, and recommend a heel to toe technique rather than a Modified Bass Technique for these areas because of the difficulty of reaching these areas for effective cleaning. Embodiments of the present invention overcome the limitations of prior art toothbrushes that may not allow an effective Modified Bass Technique, or other recommended brushing techniques, to be used in difficult to reach regions of the mouth, with: toothbrush heads which may have edges that are not straight, making it easier for a user to position the brush into the sulcus; and, with a multiple head design where one or more brush head may be offset from the shaft, allowing the user to brush difficult to reach teeth with the offset brush head, with reduced interference from a shaft when compared with a single head design without offset mounting, while enjoying the benefit of a Modified Bass Technique, or other recommended brushing technique, according to embodiments of the present invention.

Embodiments of the present invention comprise a tooth brush attachment that when mounted to most electric toothbrushes will provide full tooth coverage, with all surfaces of the teeth being brushed at the same time. By brushing buccal/facial, occlusal, and lingual surfaces all at the same time, the user will dramatically decrease the tooth brushing time required for effective oral hygiene, relative to modern electric toothbrushes.

Compared with the other known devices and solutions, embodiments of the present invention are unique, providing: effective oral hygiene with less brushing time; a more correct motion of brushing; and, the capability to be used as an attachment on existing electronic toothbrushes. In addition, the toothbrush attachment of embodiments of the present invention, when used to brush all sides and surfaces of teeth at the same time in a pushing up and down/or chewing motion, provides a cleaning action as close to the wellknown and frequently recommended brushing techniques as possible with a powered toothbrush, without requiring the user to learn the technique. Furthermore, the toothbrush attachment of embodiments of the present invention adapts to variability in tooth size for effective cleaning throughout the mouth, and accommodates varying user preference for adjustable bristle pressure, through adjustment at the base, adjustment at the head, and adjustment in between the head and the base. Brush head adjustments, in some embodiments of the present invention, for varying the spacing of components and bristle pressure, help adapt the head spacing and bristle pressure against the surface of teeth to compensate for the variation in overall tooth size and tooth thickness. Bristle pressure against tooth surfaces may be adapted for multiple reasons, including: for user comfort levels due to user preference for varying levels of bristle pressure, as some people like more or less pressure from the bristles; effective cleaning, which requires: bristle contact with teeth, and, at least a minimum pressure between bristle and teeth; and, to prevent damage to soft tissues, including gums, from excessive bristle pressure.

Embodiments of the present invention may include: full coverage bristles that fully wrap around the teeth; in some embodiments of the present invention bristles may be angled on the side to more effectively clean both difficult to reach teeth and gums; one or more of an adjustment method to compensate for different sized teeth and user preference; and, an attachment base to attach to most existing electric toothbrushes already on the market, which in general are configured as an electric toothbrush head mounted to already existing electric toothbrushes.

Embodiments of the present invention can be used by the general public, as well as special needs patients, to decrease brushing time and increase efficiency while minimizing technique sensitivity and reducing the level of manual dexterity required of effective tooth brushing. Furthermore it should be noted that if using a conventional toothbrush, the American Dental Association

recommends 2 minutes of brushing time for effective cleaning, however studies have shown that the average person spends only 68 seconds brushing. This difference in recommended brushing time vs. actual user brushing time with a prior art toothbrush, over long periods of time throughout an individual's life, will result in suboptimal oral hygiene, leading to dental aliments and other negative health outcomes; however, a toothbrush attachment of embodiments of the present invention can provide effective oral hygiene even in the limited time research data shows most people are willing to brush their teeth.

Embodiments of the present invention include a toothbrush head which provides enhanced cleaning effectiveness, while reducing the time required to maintain oral hygiene. In some embodiments of the present invention, bristle pressure is adjustable to maintain effective cleaning and user comfort levels, while adjusting for variation in tooth thickness and user preference for varying levels of pressure. In further embodiments of the present invention, bristle pressure may be automatically adjustable, and in still further embodiments, automatic bristle pressure adjustment may be constrained between a minimum and maximum bristle pressure, where the minimum and maximum bristle pressure are configurable by a user.

### BRIEF DESCRIPTION OF DRAWINGS

The above and other features, advantages, and further embodiments of the invention will become more apparent by describing in detail exemplary embodiments thereof with reference to the drawings listed below.

FIG. 1 illustrates a Toothbrush Attachment in accordance with an embodiment of the present invention.

FIG. 2 illustrates an Xshaped Toothbrush Attachment in accordance with an embodiment of the present invention.

FIG. 3 illustrates a Toothbrush Attachment having multiple heads in accordance with an embodiment of the present invention.

FIG. 4 illustrates a Drive Engagement in accordance with an embodiment of the present invention.

FIG. 5 illustrates a Toothbrush Attachment Head with brush heads in a Ushape in accordance with an embodiment of the present invention.

FIG. 6 illustrates a Toothbrush Attachment with Two Toothbrush Attachment Heads having six brush heads in accordance with an embodiment of the present invention.

FIG. 7 illustrates Two Toothbrush Attachment Heads having two Ushaped brush heads in accordance with an embodiment of the present invention.

FIG. 8 illustrates a Toothbrush Attachment Head having one Vshaped brush head in accordance with an embodiment of the present invention.

FIG. 9 illustrates Toothbrush Attachment Head single piece construction in accordance with an embodiment of the present invention.

FIG. 10 illustrates Brush Head Freedom of Movement in accordance with an embodiment of the present invention.

FIG. 11 illustrates a Brush Head with nonflat brushing surface and brush head freedom of movement traversing Lingual region in accordance with an embodiment of the present invention.

FIG. 12 illustrates a Toothbrush Attachment having tension adjustment in accordance with an embodiment of the present invention.

FIG. 13 illustrates Assembly of Toothbrush Attachment in accordance with an embodiment of the present invention.

FIG. 14 illustrates Bristle Angle and Brush Head Spacing Adjustments in accordance with an embodiment of the present invention.

FIG. 15 illustrates Bristle Angle and Brush Head Spacing Lock in accordance with an embodiment of the present invention.

FIG. 16 illustrates Automatic Bristle Pressure Adjustment in accordance with an embodiment of the present invention.

### DETAILED DESCRIPTION OF THE INVENTION

For the purpose of this disclosure, Bristle Pressure is defined as the force between one or more bristle end and one or more surface area. Effective Bristle Pressure includes a range of Bristle Pressure between a minimum Bristle Pressure achieving contact of bristle end with a surface, and a maximum Bristle Pressure bending one or more bristle. Effective Bristle Pressure includes pressure sufficient for bristle contact with a surface up to the bristle pressure sufficient to bend one or more bristle.

Tooth surfaces are described in the disclosure herein using terms common to the art of dentistry and known to the general public. In particular, reference is made to tooth surfaces including tooth side surfaces or sides of teeth, as distinguished from tooth biting surfaces. For the purpose of the disclosure herein, a reference to a tooth side surface or a side of a tooth are considered equivalent, and such a reference is intended to include any normally exposed tooth surface that is not a tooth biting surface, in addition to the plain meaning of the common definition of such term; tooth side surfaces may also include, in dental terminology, buccal, labial, lingual, palatial surfaces. For the purpose of the disclosure herein, a reference to a tooth biting surface is intended to include any normally exposed tooth surface of a tooth protruding from one arch, which when a patient bites down, may contact an opposing tooth surface of a tooth protruding from the opposing arch, in addition to the plain meaning of the common definition of such term; such tooth surfaces may be known in the art of dentistry as Occlusal surfaces, which a reference to a tooth biting surface is also intended to include.

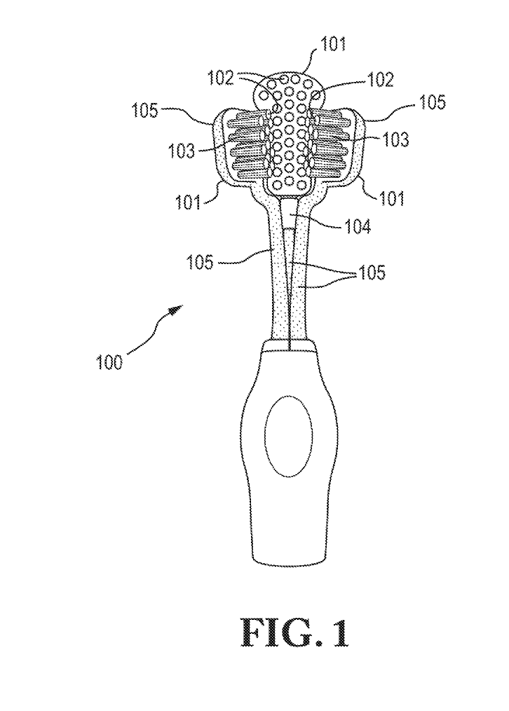

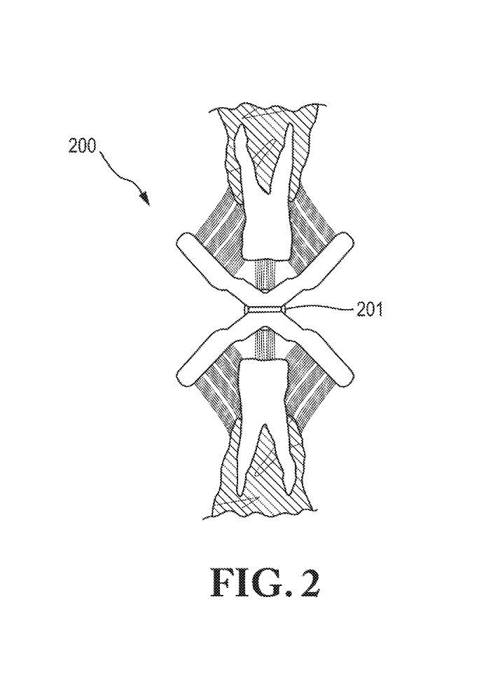

As illustrated in FIG. 1, embodiments of the present invention may comprise: a toothbrush attachment 100, with one or more toothbrush head 101 angled to the sides of teeth, and having, when in use brushing a patient's teeth, one or more toothbrush head 101 having at least one toothbrush head cleaning surface 102, for full coverage of teeth with brushing bristles 103 on the Lingual, Occlusal, and Buccal/Facial areas at the same time; one or more adjustment 104 to account for variation in tooth size; and, soft padding 105 on outside surfaces to avoid discomfort or damage to the user from accidental touching of hard surfaces of the mouth due to vibration of the toothbrush attachment. As illustrated in FIG. 2, components of the toothbrush attachment of embodiments of the present invention may be connected via a toothbrush head having an Xshaped design 200 that hugs all sides of the teeth in both upper and lower arches at the same time, to allow for brushing all sides of multiple teeth on both arches at the same time completely at once, and having one or more adjustment 201 of spacing between brush heads.

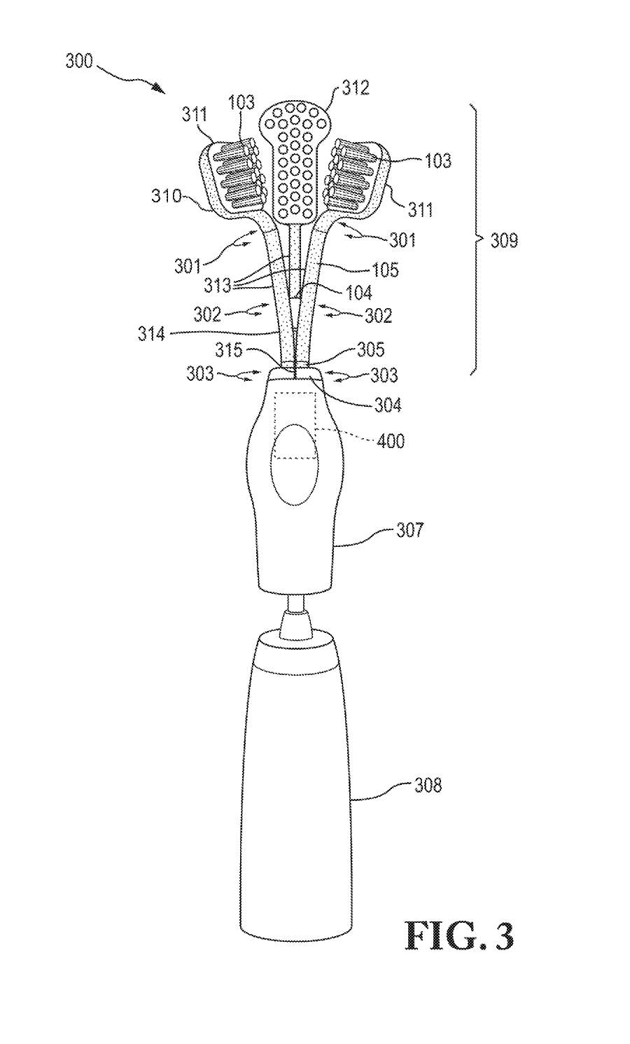

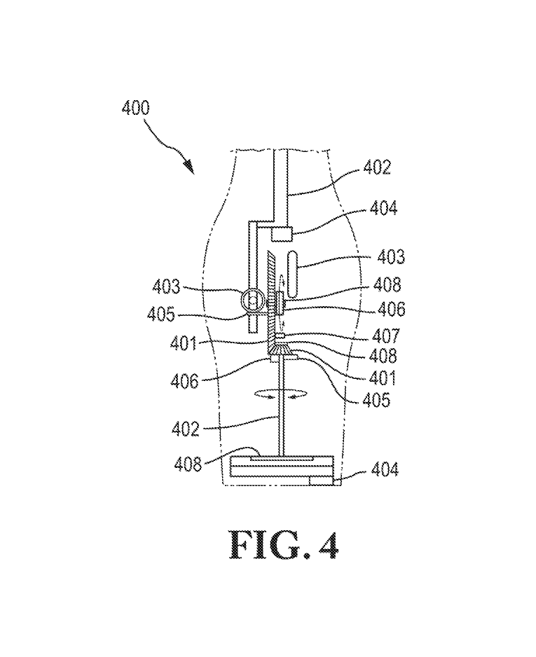

As illustrated in FIG. 3, a toothbrush attachment 300 of embodiments of the present invention may include one or more of: one or more toothbrush attachment head 310 having fullcoverage shaped bristles 103 engaging the Lingual, Occlusal, Buccal/Facial tooth surfaces; a variable interface 309, comprising one or more adjustment to one or more toothbrush attachment head 310, one or more toothbrush head 101 or one or more shaft 313, the variable interface 309 enabling adjustability 301 at the heads to account for varying width and sizes of teeth; adjustability 302 at the stem 305 to account for varying width and sizes of teeth; adjust ability 303 at the base 304 to account for varying width and sizes of teeth; soft padding material 105 on the outside of the toothbrush head, to minimize the impact of the vibration if the exterior surface of the toothbrush accidentally hits other teeth; and, a drive engagement 400 according to embodiments of the present invention as illustrated in FIG. 4, comprising one or more of: one or more gear 401, one or more drive shaft 402, one or more cam 403, or one or more torque converter 404, at the toothbrush attachment base 304, the one or more of: one or more gear 401, one or more drive shaft 402, one or more cam 403, or one or more torque converter 404 configured to convert circular motion or left and right reciprocating motion powered brushes to either sidetoside (also referred to as back and forth) movement, or up anddown movement, in accordance with tooth brushing techniques recommended for effective oral hygiene. In some embodiments of the present invention one or more gear 401 may comprise a Bevel Gear, or any other type of gear known to one of ordinary skill in the art. In some embodiments of the present invention, one or more drive shaft 402 may be flexible, straight, one piece, or multiple pieces operatively coupled with one or more coupling as known to those of ordinary skill in the art. In some embodiments of the present invention toothbrush attachment base 304 may be operatively coupled to handle 307, with handle 307 attached to a toothbrush base 308, wherein toothbrush base 308 may be a powered toothbrush base or a nonpowered toothbrush base. In further embodiments of the present invention handle 307 may connect toothbrush attachment base to an unpowered toothbrush handle. A drive engagement 400 in accordance with embodiments of the present invention when mounted to an existing powered toothbrush base, including a piezoelectric toothbrush type and other powered toothbrush types, moves the brush heads and bristles in accordance with a correct and effective recommended brushing technique. In some embodiments of the present invention a drive engagement 400 as illustrated in FIG. 4 may further include one or more of: one or more tensioning means 405, which tensioning means may include one or more springs; one or more retaining means 406, which retaining means may include one or more latches; or one or more interlocking means 407, which interlocking means may include one or more springloaded retractable pins, wherein one or more of one or more tensioning, retaining, or interlocking means may be operatively embedded, connected, coupled, or attached to, within, or upon the one or more of: one or more gear 401, one or more drive shaft 402, one or more cam 403, or one or more torque converter 404, wherein one or more of one or more tensioning means 405, retaining means 406, or interlocking means 407 may adaptively configure the one or more of: one or more gear 401, one or more drive shaft 402, one or more cam 403, or one or more torque converter 404, to react to the type of powered toothbrush input motion by engaging a first one or more gear or one or more cam with at least a second one or more gear or one or more cam, in which at least one gear may be drivably attached to a driveshaft the axis of which may be disposed with a spatial or angular offset from the center of rotation of at least one gear, to convert circular motion or left and right reciprocating motion to sidetoside (also referred to as backandforth) movement according to the type of input motion. In some embodiments of the present invention, one or more gear 401, or cam 403 may be operatively coupled to one or more drive shaft 402 through one or more drive shaft, cam, or gear retaining and adjusting means 408, which may include one or more slot, track, channel, gimbal, swivel, or pivot mount, in one or more gear 401 or cam 403, such that a gear 401, drive shaft 402, or cam 403 may have a plurality of degrees of freedom while operatively coupling a powered toothbrush base to a toothbrush attachment according to embodiments of the present invention. In a nonlimiting example, for some embodiments of the present invention, a powered toothbrush base may be operatively coupled to a Drive Engagement 400 via a drive shaft 402 positioned to drive one or more gear 401, the one or more gear positioned to engage another gear at an angle to the one or more gear having at least one drive shaft 402 positioned at an offset displacement or angle from a gear center of rotation, the displacement offset or angle of one or more gear or one or more shaft positioned to convert each left or right reciprocating input motion from a powered toothbrush to approximately onehalf rotation of an input gear, the input gear further engaged at the outer edge to another gear having a plane diameter substantially perpendicular to the plane diameter of an input gear, such that when the powered toothbrush provides leftandright reciprocating motion the input gear moves in approximate halfrotations, and such that a gear engaged with the input gear and having a plane diameter substantially perpendicular to the plane diameter of the input gear moves a drive shaft to provide sidetoside motion. In further embodiments of the present invention, a Drive Engagement 400 may detect and adaptively configure for the motion type, such that if one or more retaining, tensioning, or interlocking means including a springloaded retractable pin is engaged or depressed by the presence of circular motion depressing the one or more pin to a shaft or gear when an input shaft moves substantially beyond a halfrotation in either direction, the angle or offset of the input gear drive shaft is reconfigurably adjusted from a first position to a second position by one or more of tensioning, retaining, or interlocking means such that the input gear drive shaft is disposed substantially inline with the powered toothbrush centerline 315 and substantially in the center of the input gear, the gear having a plane diameter substantially perpendicular to the input gear is disengaged from the input gear, and one or more of tensioning, retaining, or interlocking means reconfigurably couple the drive shaft of input gear to drive the toothbrush attachment with circular motion, and Drive Engagement 400 reconfigurably adapts, from converting leftandright reciprocating motion to sidetoside movement, to converting circular motion to sidetoside movement. In some embodiments of the present invention, Drive Engagement 400 is further configured to detect and adaptively configure for the motion type, such that if one or more retaining, tensioning, or interlocking means including one or more springloaded retractable pin are not engaged or depressed by the presence of circular motion depressing the one or more pin to a shaft or gear when an input shaft moves substantially beyond a halfrotation in either direction, the angle or offset of the input gear drive shaft is reconfigurably adjusted from a first position to a second position by drive shaft, cam, or gear retaining and adjusting means such that the input gear drive shaft is disposed at an offset displacement or angle to the powered toothbrush centerline 315 and offset to the center of the input gear, and Drive Engagement 400 reconfigurably converts, from converting circular motion to sidetoside movement, to converting left and right reciprocating motion to sidetoside movement. In further embodiments of the present invention, a Drive Engagement 400 may be configured with one or more cam 403, one or more tensioning means, or one or more drive shaft, cam, or gear retaining and adjusting means, to operatively couple one or more cam 403 to one or more drive shaft 402 and convert sidetoside motion to upanddown motion. In still further embodiments of the present invention, a useroperable selector may be configured to reconfigurably select sideto side or upanddown motion, independent of the input motion type, in accordance with embodiments of the present invention.

In some embodiments of the present invention as illustrated in FIG. 3, the one or more of a brush head adjustment 104 may include: adjustment of distance between brush heads 311 or 312; adjustment of tension between brush heads 311 or 312; or, adjustment of force of one or more brush head 311 or 312 against one or more tooth surface, wherein said one or more brush head adjustment 104 may operate for various purposes, including: to compensate for the difference between tooth size and thickness within a single user's mouth; to compensate for the difference between tooth size and thickness from user to user, that is, to compensate for variation in dentition size from individual to individual; to adjust bristle pressure to avoid damage to gums and other soft tissues from excessive pressure; or, to adjust bristle pressure to ensure sufficient bristle contact or bristle pressure on the teeth or gums for effective cleaning.

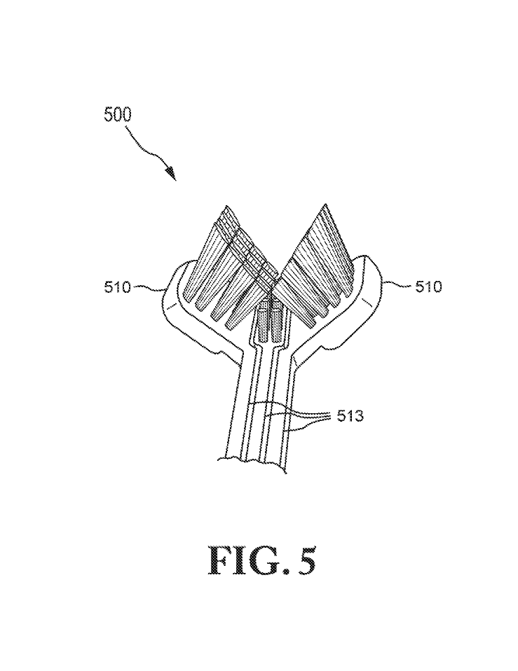

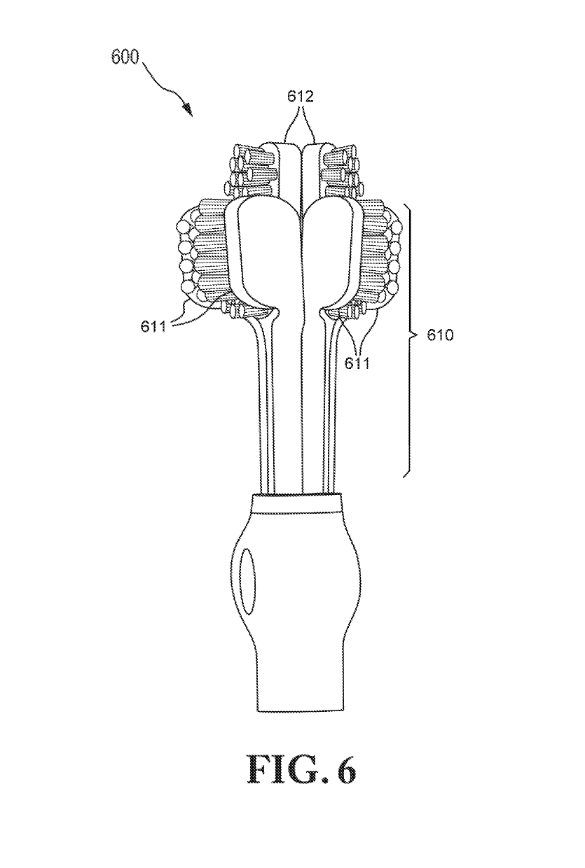

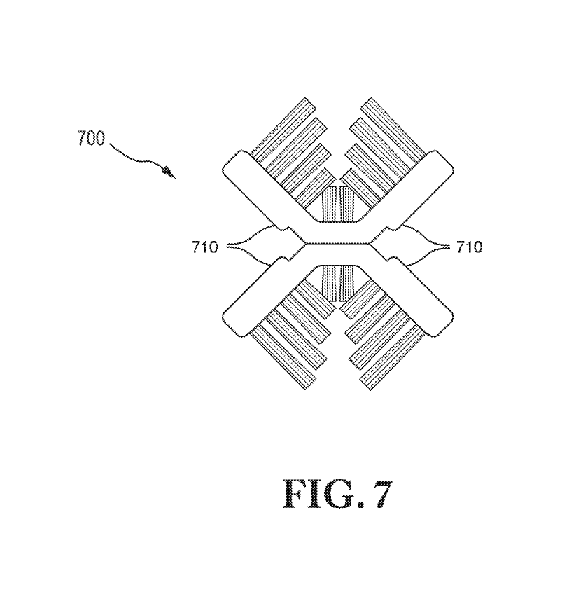

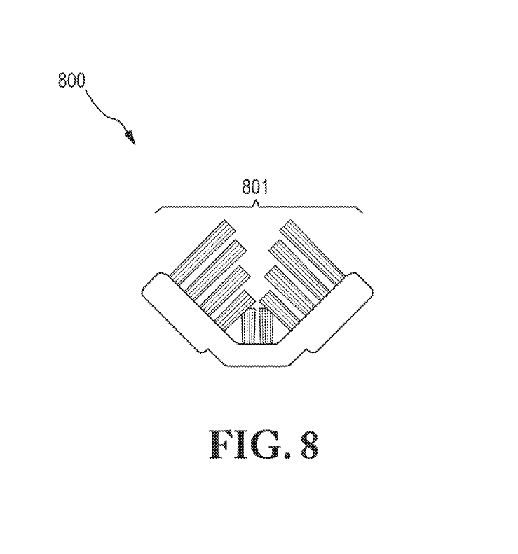

Embodiments of the present invention comprise a toothbrush attachment 300 as illustrated in FIG. 3, having one or more toothbrush attachment head 310. A toothbrush attachment head 310 of embodiments of the present invention may have one or more of a brush head 311 or 312 attached to one or more shaft 313 in accordance with embodiments of the present invention. A toothbrush attachment head 310 of embodiments of the present invention may be configured in multiple and various combinations or configurations of brush heads 311 or 312 and bristle 103 angles, without departing from the teaching disclosed herein and while still falling within the scope of embodiments of the present invention. In the disclosure herein of embodiments of the present invention, a side brush head 311 typically cleans one or more tooth side surface; a center brush head 312 typically cleans one or more tooth biting surface. In some embodiments of the present invention, a toothbrush attachment head 310 may comprise three brush heads, including a center brush head 312 cleaning tooth biting surfaces, and two side brush heads 311 cleaning tooth side surfaces, as illustrated in FIG. 3. In further embodiments of the present invention, a toothbrush attachment head 500 may comprise brush heads 510 and shafts 513, which brush heads may be configured in a ‘Ushape’ as illustrated in FIG. 5. In still further embodiments of the present invention, a toothbrush attachment head may comprise one or more arcshaped head, rounded head, or a head with different bristle angles, or any other combination of head shape, bristle arrangement, bristle disposition, or bristle angle, without departing from the teaching of the present application and while still falling within the scope of the claimed embodiments of the present invention. One toothbrush attachment head 310 of embodiments of the present invention may clean one of an upper or lower arch. As a nonlimiting example, a toothbrush attachment 600 of an embodiment of the present invention as illustrated in FIG. 6, having two toothbrush attachment heads 610 may have six brush heads: said six brush heads including two side brush heads 611, and a center brush head 612 for an upper arch, and two side brush heads 611 and a center brush head 612 for a lower arch. In another nonlimiting example, a toothbrush attachment 700 of a further embodiment of the present invention having two toothbrush attachment heads 710 may have two brush heads: each brush head configured in a ‘Ushape’ and integrating the side brush heads and a center brush head into a single ‘Ushaped’ head as illustrated in FIG. 7, for full tooth bristle coverage of both tooth side surfaces and tooth biting surfaces at the same time; in such an embodiment of the present invention, one Ushaped head would clean an upper arch, and one ‘Ushaped’ head would clean a lower arch. In an additional nonlimiting example, a toothbrush attachment 800 of a still further embodiment of the present invention may have one toothbrush attachment head 801, as illustrated in FIG. 8, said toothbrush attachment head having one brush head, said brush head configured in a ‘Vshape’ and integrating the side brush heads and a center brush head into a single ‘Vshaped’ head 801, for full tooth bristle coverage of both sides and biting surfaces at the same time; in such an embodiment of the present invention, one V shaped head 801 would clean one arch at a time, and a user may alternately position, into either the upper or lower arch, the toothbrush attachment of an embodiment of the present invention, for fullcoverage cleaning.

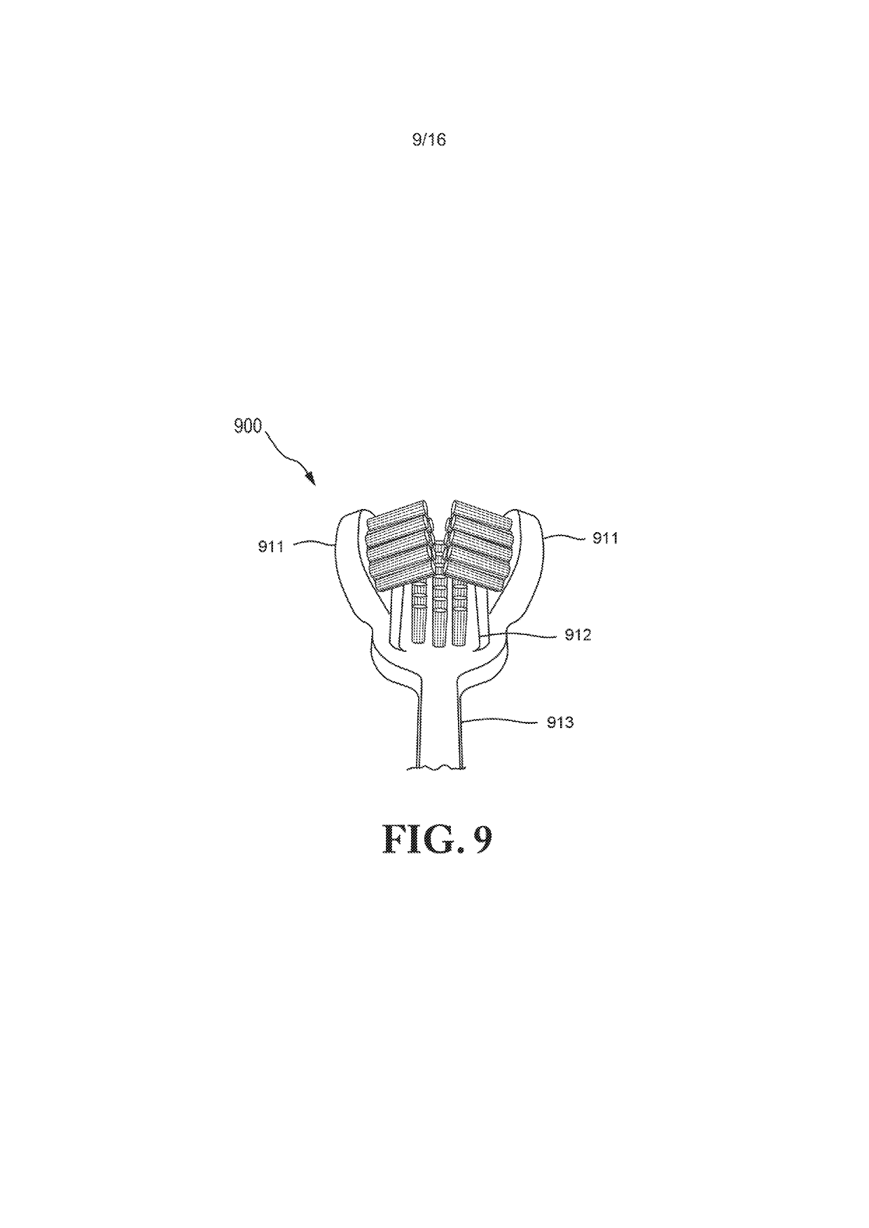

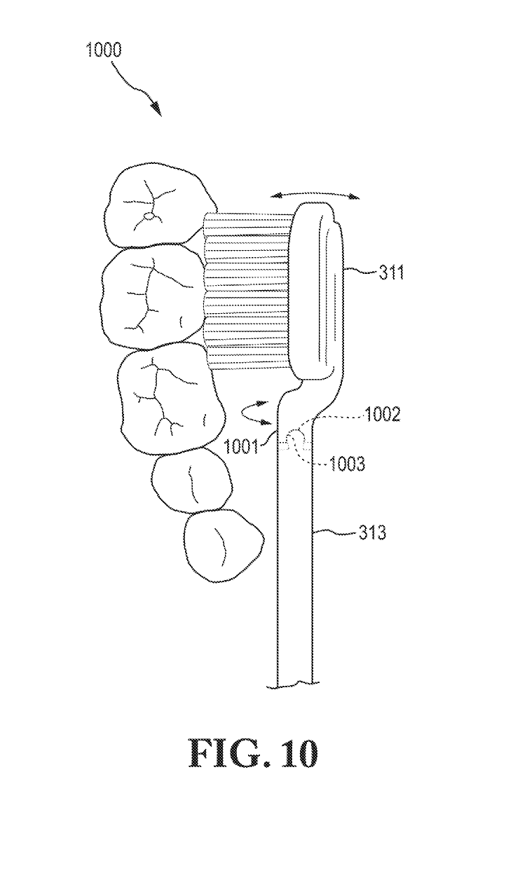

A toothbrush attachment head of some embodiments of the present invention may comprise a single piece construction 900 comprising two side brush heads 911, a center brush head 912, and shaft 913 as illustrated in FIG. 9. A toothbrush attachment of embodiments of the present invention includes one or more shaft having one or more brush head. In some embodiments of the present invention, a brush head and shaft may comprise separate components which fit together, having in some embodiments brush head freedom of movement 1000 which may include a moveable brush head mount 1001, said moveable brush head mount 1001 including: a gimbal mount, a pivot mount, or ballandsocket mount, between the brush head and shaft; in a nonlimiting example, a brush head mount may include a balltype endpoint 1002 on a shaft pressed into a socket receptacle 1003 on a brush head as illustrated in FIG. 10, such that the brush head is rotationally coupled to the shaft to allow the brush head freedom of movement about the mount point for more effective cleaning of teeth and gums in difficult to reach areas of the mouth.

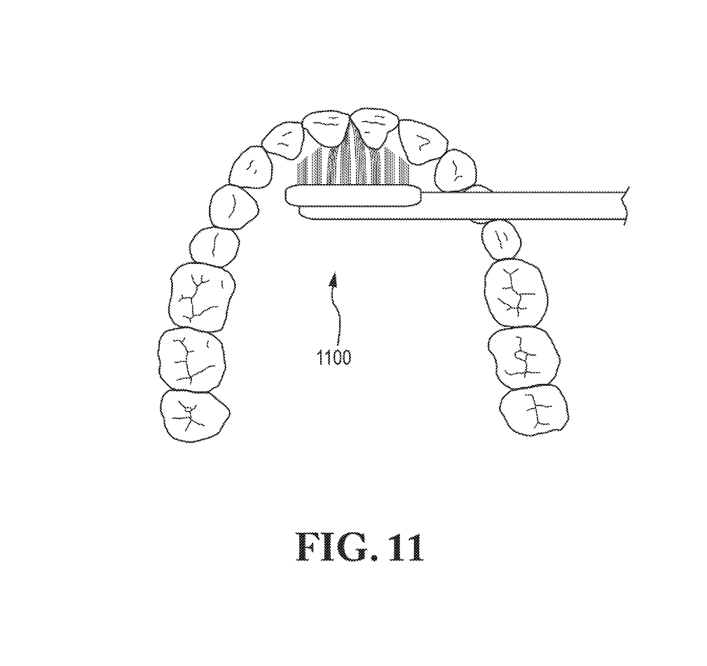

In some embodiments of the present invention a brush head may be rectangular, oval, elliptical, round, or any other shape, having at least one brush head brushing surface 102 from which bristles 103 protrude. In some embodiments of the present invention, a brush head brushing surface 102 of a brush head may be flat, or may be convex out with respect to the tooth surface, or may be rounded, or otherwise not flat, for more effective cleaning of teeth in difficult to reach areas of the mouth, in particular as one or more brush heads of embodiments of the present invention traverse the Lingual region as illustrated in FIG. 11, said one or more brush heads optionally having freedom of movement as herein disclosed in some embodiments of the present invention and as illustrated in FIG. 10, to follow the contour of teeth as the user moves the toothbrush attachment 1100 of embodiments of the present invention throughout the mouth, to assist the user in accessing constrained areas of the mouth with the brush head for effective cleaning, especially the Anterior Lingual regions. Some dental professionals have noted some areas, such as the Anterior Lingual region, are difficult to clean with a prior art toothbrush head according to some recommended brushing techniques, due to the difficulty of reaching these areas with the brush head. Because of the difficulty in reaching the Anterior Lingual region of the mouth, and other regions of the mouth that may be difficult to reach with a prior art brush head, some dental practitioners recommend different techniques for cleaning the Anterior Lingual region, such as a heeltotoe motion. Embodiments of the present invention that allow freedom of movement of a brush head to follow the contour of the teeth, and maintain bristle pressure as the bristles are moved along the contour of the teeth, help overcome the deficiencies of the prior art and allow the more effective recommended techniques to be used effectively with embodiments of the present invention even in areas of the mouth where dental professionals have recommended other techniques with prior art toothbrushes, due to the difficulty of reaching these areas, such as the Anterior Lingual region, with conventional toothbrushes.

A brush head of embodiments of the present invention may include a soft material on the outer brush head surface, said soft material providing a soft padding on the brush head outside surfaces to avoid discomfort or damage to the user from accidental touching of hard surfaces of the mouth due to vibration of the toothbrush attachment.

As illustrated in the accompanying figures, a toothbrush attachment head of embodiments of the present invention include one or more shaft having one or more brush head, in accordance with embodiments of the present invention. In some embodiments of the present invention, one or more shaft may be mounted to an attachment base, such that the shaft ends mounted to the attachment base are close enough together as to be almost touching. In some embodiments of the present invention, bristle angle with respect to tooth side surfaces is adjustable for effective cleaning, said adjustment comprising moving, bending, and/or twisting said one or more shaft and varying the distance between one or more shaft. Bristle angle of embodiments of the present invention may be adjusted to fortyfive degrees with respect to a tooth side surface in accordance with the Modified Bass Technique, however the bristle angle may also be adjusted to any angle preferred by a user or recommended by a dental practitioner in accordance with embodiments of the present invention as further disclosed herein.

A shaft of embodiments of the present invention may be flexible, allowing adjustment of bristle angle for effective cleaning in accordance with a recommended technique or in compliance with user comfort or technique variation. In addition to having flexibility, a shaft of embodiments of the present invention may retain new shapes, comprising a shape shifting memory or smart material 314. The shapeshifting memory or smart material 314 helps to adjust for varying teeth widths between individuals, assists the user in bending or adjusting the brush heads and bristle 103 angle for optimal cleaning and comfort, and helps the side heads return to their original position and angle when displaced by the force between a user's teeth and bristles 103 of toothbrush attachments of embodiments of the present invention. A shaft of embodiments of the present invention may comprise a soft material 105 on the outer shaft surface, providing a soft padding on the shaft outside surfaces to avoid discomfort or damage to the user from accidental touching of hard surfaces of the mouth due to vibration of the toothbrush attachment. A shaft of embodiments of the present invention may be rigid, or flexible, comprising a plastic or rubber material, or a shapeshifting memory or smart material, and a shaft may be adjustable, retain new shapes, or resist change in shape, depending on the material used. One or more shaft of embodiments of the present invention may be preformed to a usable shape, and a user may also adjust one or more shaft 313 for optimal cleaning and comfort.

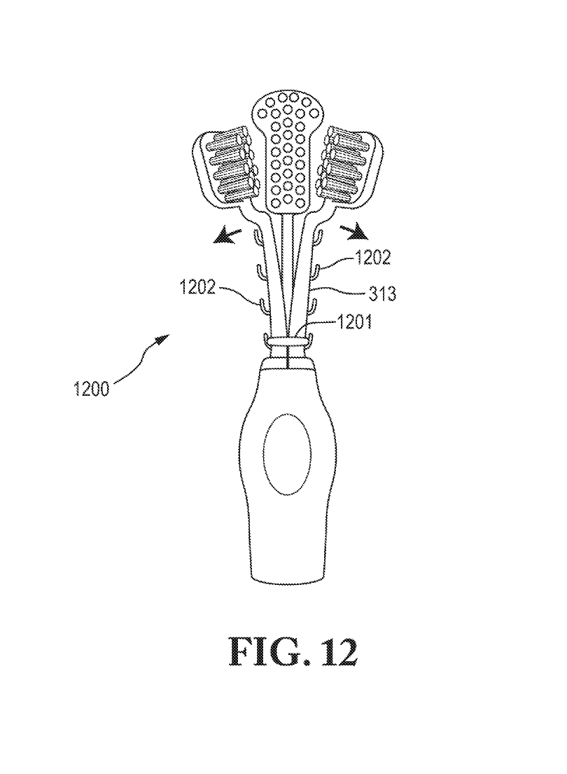

In accordance with some embodiments of the present invention, as illustrated in FIG. 12, a tension adjustment system 1200 may comprise one or more brush head, and one or more shaft 313. The one or more shaft 313 may be configured with one or more tension adjustment point 1202 to attach one or more tension stabilizer 1201 to adjust or maintain bristle pressure or bristle force as the user moves the toothbrush attachment throughout the mouth and across teeth of varying thickness and along varying contours of the teeth. A tension adjustment point 1202 of embodiments of the present invention may include a hook, pin, clasp, clamp, notch, groove, or other protrusion from the surface of a brush head or shaft, or indentation into the surface of a brush head, or shaft, which protrusion or indentation may retain one or more tension stabilizer 1201. A tension stabilizer 1201 of embodiments of the present invention may include an elastic band, a spring, a rubber band, or a string, ribbon, or strand having elasticity. Embodiments of the present invention may include one or more tension adjustment point 1202 for one or more tension stabilizer 1201 attached to one or more shaft 313 or one or more brush head, to adjust or maintain bristle pressure or force between one or more bristle and one or more tooth for effective cleaning. Embodiments of the present invention may include one or more tension adjustment point 1202 for one or more tension stabilizer 1201 to make bristle force against teeth uniform even when the tooth width changes. Further embodiments of the present invention may include one or more moveable tension adjustment point 1202 for one or more tension stabilizer 1201 to increase pressure or decrease pressure by sliding up and down moveable tension adjustment point 1202 for one or more tension stabilizer 1201 to increase pressure or decrease pressure. Embodiments of the present invention may include notches or voids along one or more shaft 313 end, enabling the user to choose to locate one or more tension stabilizer 1201, at different points for different tension ranges. In embodiments of the present invention including one or more tension stabilizer 1201, one or more shaft 313 may be rigid. In embodiments of the present invention not using one or more tension stabilizer 1201, shafts may be flexible while retaining shape in accordance with embodiments of the present invention.

In some embodiments of the present invention one or more side brush head 311 may extend from a shaft 313 disposed with an angled offset between the brush head and shaft at a brush head end, displacing one or more side brush head from a center brush head, which center brush head in some embodiments may be mounted to a shaft extending straight from the handle assembly 307. The angled offset between a brush head and shaft at a brush head end assists in adjustment of the distance and pressure to the tooth surfaces being cleaned, in addition to assisting the user in cleaning teeth and gums in difficult to reach areas by allowing the user to reach teeth in these areas with less interference between the teeth and shaft when compared to a prior art toothbrush. The distance between shafts 313 at the brush head ends may vary depending on the length of shaft used, the thickness of the teeth being cleaned, and the adjustment settings in use.

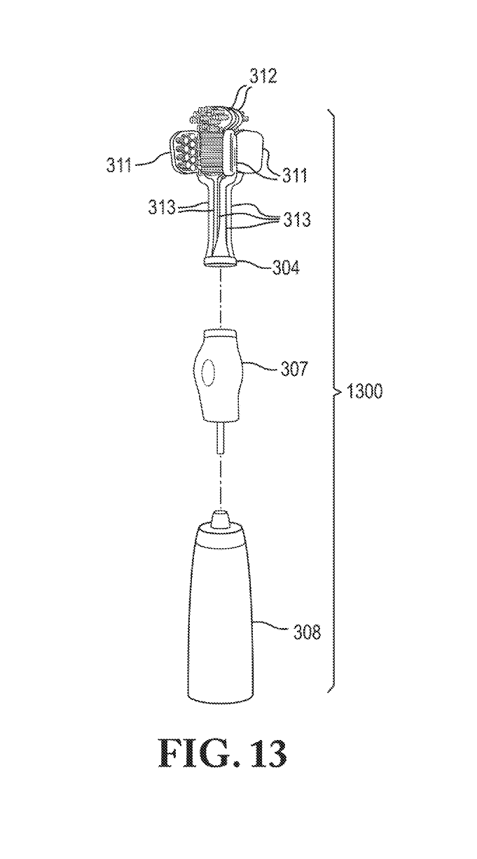

In some embodiments of the present invention shafts and brush heads may be onepiece construction, and in further embodiments of the present invention, shafts and brush heads may be separate components attached together. As illustrated in FIG. 13, in some embodiments brush heads 311 or 312 may be assembled 1300 to shafts 313, shafts 313 may be assembled to a handle 307, and the handle 307 with attached brush heads 311 or 312 and shafts 313 is attached to a toothbrush base 308 by attachment base 304.

Bristles 103 of embodiments of the present invention may be standard nylon, or any toothbrush bristle material known to one of ordinary skill in the art. Bristles 103 protrude from a brush head, with bristle 103 angle with respect to one or more tooth surface changed by adjusting the angle of the brush heads in accordance with embodiments of the present invention.

Embodiments of the present invention include multiple features to assist the user in achieving more effective oral hygiene with reduced brushing time, when contrasted with the prior art. In addition to the fulltooth bristle coverage of the multi head design of embodiments of the present invention, which reduces required brushing time by cleaning multiple tooth surfaces all at the same time, embodiments of the present invention include manual and automatic adjustments to further assist the user in achieving improved oral hygiene. The adjustments of embodiments of the present invention include: bristle angle and brush head spacing adjustment, for optimal cleaning in accordance with recommended brushing technique, and to accommodate user preference and comfort level; bristle angle and brush head spacing lock adjustment, enabling the preferred bristle angle and brush head spacing selected by a user to be locked or retained in place for consistent cleaning performance; and, automatically adjustable bristle pressure, to maintain pressure between bristles and teeth for consistent and effective cleaning.

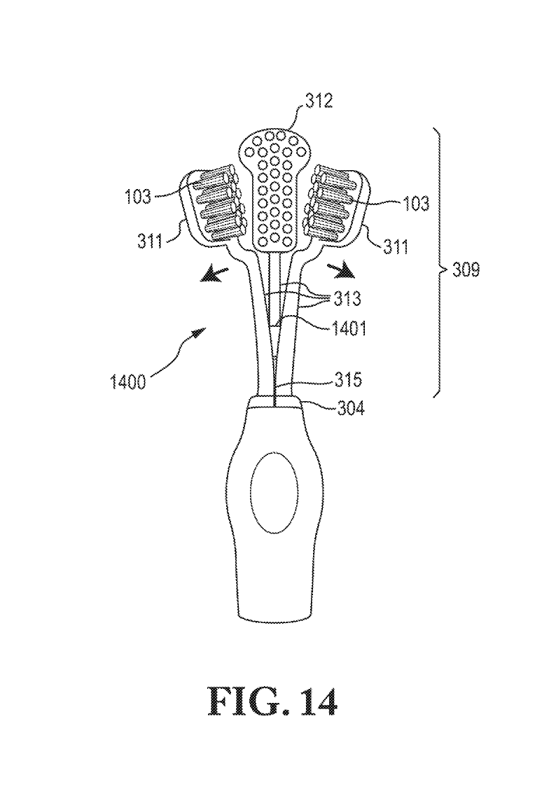

As illustrated in FIG. 14, spacing and angle adjustment system 1400, bristle 103 angle adjustment and adjustment of brush head 311 or 312 spacing of embodiments of the present invention may be enabled by adjusting the threedimensional arrangement of shafts 313 and brush heads 311 or 312, including varying angle and spacing of one or more shaft 313, or one or more brush head 311 or 312, relative to the centerline 315 of attachment base 304 or relative to one or more other shaft 313 or other brush head 311 or 312. In some embodiments of the present invention, a user may adjust bristle angle or brush head 311 or 312 spacing by bending one or more shaft 313. In some embodiments of the present invention, as illustrated in FIG. 14, bristle 103 angle or brush head 311 or 312 spacing may be adjustable by moving, longitudinally with respect to the centerline 315 of attachment base 304, an angle or spacing adjustment mechanism 1401, which angle or spacing adjustment mechanism 1401 may be a wedge disposed between one or more shaft 313, where moving the adjustment mechanism toward the brush head 311 or 312 end decreases the angle and spacing between shafts 313 and brush heads 311 or 312, and moving the angle or spacing adjustment mechanism 1401 away from the brush head 311 or 312 end increases the angle and spacing between shafts 313 and brush heads 311 or 312. In addition to a sliding ring, an angle or spacing adjustment mechanism 1401 of embodiments of the present invention may include: a ring, wedge, staple, nail, double nail, clamp, clasp, pin and socket, button, tie, or other movable fastener.

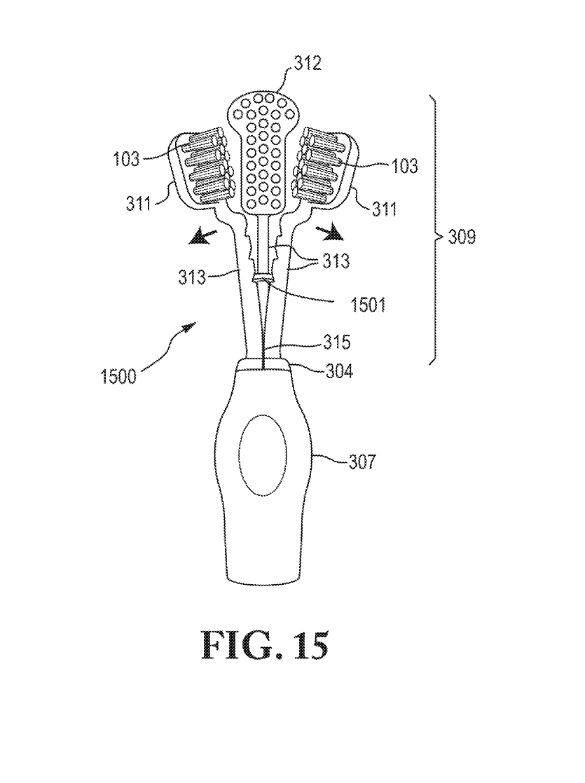

As illustrated in FIG. 15, bristle 103 angle and brush head 311 or 312 spacing lock adjustment system 1500 of embodiments of the present invention may be enabled with an angle or spacing locking mechanism 1501 allowing a user to secure an angle or spacing adjustment mechanism 1501 in a position selected by a user. An angle or spacing locking mechanism 1501 of embodiments of the present invention may include one or more indentation, notch, detent, tooth, ring, pin, button, or other void, in one or more shaft 313 or attachment base 304, enabling an angle or spacing adjustment mechanism 1501 to be retained in a selected adjustment position, which adjustment position in some embodiments of the present invention may further comprise a function of variable interface 309. In some embodiments of the present invention, an angle or spacing locking mechanism 1501 of embodiments of the present invention may include a plurality of angle or spacing adjustment mechanism 1501 to provide a plurality of adjustment levels for bristle 103 angle or spacing. In further embodiments of the present invention, an angle or spacing locking mechanism 1501 of embodiments of the present invention may include certain notches or indentations providing preset angles or spacing in accordance with preferred angles or spacing, including, in a nonlimiting example, a preset fortyfive degree angle in accordance with a Modified Bass Technique.

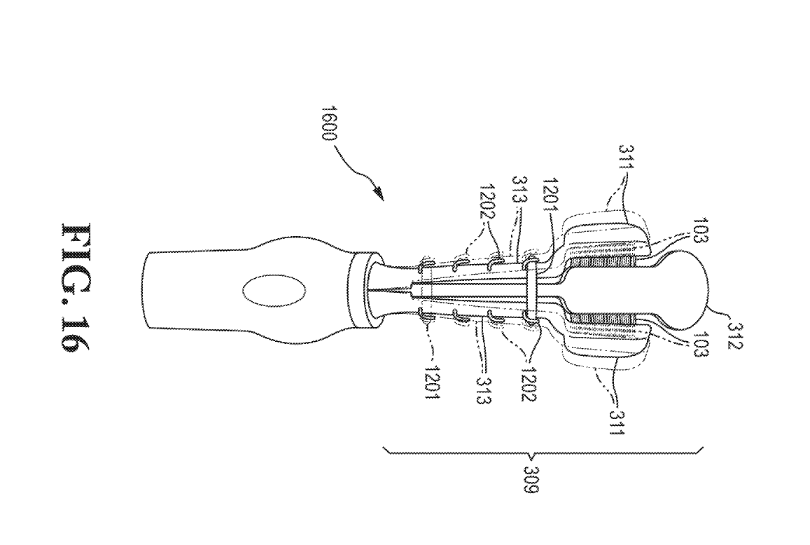

As illustrated in FIG. 16, automatic bristle pressure adjustment system 1600 of embodiments of the present invention may be enabled by one or more tension stabilizer 1202, attached at a plurality of tension stabilizer attachment points 1201 between a brush head 311 or 312 and either another brush head 311 or 312 or shaft 313. A tension stabilizer 1202 of embodiments of the present invention may include: an elastic band, rubber band, spring, string, thread, or other elastic strand or loop. A tension stabilizer attachment point 1201 of embodiments of the present invention may include: a notch, clamp, hook, pin, clasp, detent, tooth, or void, on or in a brush head or shaft, retaining one end of a tension stabilizer 1202. When attached by a user between tension stabilizer attachment points 1201, one or more tension stabilizer 1202 provides a force resisting change in bristle angle and bristle pressure and assists in maintaining a consistent cleaning performance throughout the mouth. The tension stabilization system 1600 of embodiments of the present invention provide an automatic adjustment for constant bristle pressure through an active adjustment that occurs automatically with the tension in one or more tension stabilizer 1202, and helps maintain a minimum bristle pressure for effective cleaning as different parts of the mouth are cleaned. The automatically adjustable bristle pressure of embodiments of the present invention enabled by one or more tension stabilizer 1202 and tension stabilizer attachment points 1201 permit a user to position one or more tension stabilizer 1202 between brush heads 311 or 312 or shafts 313 to normalize the bristle pressure for more effective cleaning, as the toothbrush attachment of embodiments of the present invention is moved across varying tooth contours and teeth of varying thickness. In some embodiments of the present invention, a plurality of tension stabilizer attachment points 1201 may be positioned along one or more shaft 313 or brush head 311 or 312, enabling the user to choose different points and thus different starting tension and corresponding range of bristle 103 pressure, by placing a tension stabilizer 1202 at different tension stabilizer attachment points 1201.

Certain features described in the context of various embodiments are not to be considered essential features of those embodiments, unless the embodiment is inoperative without those elements.

A detailed description of one or more embodiments of the invention is provided herein along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the description herein in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Throughout this application, various features, capabilities, characteristics, qualities, or other properties, of various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range. Whenever a numerical range is indicated herein, it is meant to include any cited numeral (fractional or integral) within the indicated range, unless otherwise explicitly or implicitly limited to integral values. The phrases “ranging/ranges between” a first indicated number and a second indicated number and “ranging/ranges from” a first indicated number “to” a second indicated number are used herein interchangeably and are meant to include the first and second indicated numbers and all the fractional and integral numerals there between.

For the sake of clarity, processes and methods herein may have been illustrated with a specific flow, but it should be understood that other sequences may be possible and that some may be performed in parallel, without departing from the spirit of the invention. Additionally, steps may be subdivided or combined. It will be understood by one of ordinary skill that an embodiment can contain an alternate order of the steps, or an alternate configuration or arrangement of elements, adapted to a particular application disclosed herein. All such variations and modifications are intended to fall within the scope of this disclosure. The depiction and description of steps in any particular order or elements in any particular arrangement is not intended to exclude embodiments having the steps in a different order or elements in a different arrangement, unless required by a particular application, explicitly stated, otherwise clear from the context, or unless the order or arrangement would render an embodiment inoperative. Although the present invention has been described above in terms of specific embodiments, it is anticipated that alterations and modifications to this invention will no doubt become apparent to those skilled in the art and may be practiced within the scope and equivalents of any appended claims.

Benefits, features, and advantages of the present invention, in addition to the structure and arrangement of various embodiments of the present invention, are described in detail herein, with reference to the accompanying drawings. Note that the embodiments of the invention disclosed herein are illustrative and explanatory of the invention, and do not limit the invention to those specific embodiments disclosed. Those with ordinary skill in the relevant art(s) will recognize additional embodiments of the invention beyond those disclosed herein, in view of what is commonly known in the art(s) and the teaching herein.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

It is expected that during the life of a patent maturing from this application many relevant new technologies in various related fields will be developed and the scope of the related terms used herein are intended to include all such new technologies a priori.

As used herein, the singular form “a”, “an” and “the” include plural references unless the context clearly dictates otherwise. For example, the term “a compound” or “at least one compound” may include a plurality of compounds, including mixtures thereof.

As used herein the term “about” refers to plus or minus ten percent, unless otherwise indicated, in addition to the plain meaning of the common definition(s) of the term.

The terms “comprises”, “comprising”, “includes”, “including”, “having” and their conjugates mean “including but not limited to”. This term encompasses the terms “consisting of” and “consisting essentially of”. Anywhere the term “comprising”, “comprises”, “comprise”, “comprised”, “including”, “include”, or “includes” are used, embodiments and components “consisting essentially of” and “consisting of” are expressly disclosed and described herein.

As used herein, the term “substantially” refers to the condition, or state, of a subject element almost completely or nearly completely, or completely within reasonable judgement of an ordinary person using or observing the element or operation, as having the property or condition.

The phrase “consisting essentially of” means that the composition or method may include additional ingredients and/or steps, but only if the additional ingredients and/or steps do not materially alter the basic and novel characteristics of the claimed invention, or render the claimed invention or embodiment thereof inoperative.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The words “optionally”, “may include”, or “may comprise” are used herein to mean “is provided in some embodiments and not provided in other embodiments”. Any particular embodiment of the invention may include a plurality of “optional” features unless such features conflict or render the invention inoperative.

The present embodiments are to be considered as illustrative and not restrictive, and the invention is not to be limited to the details given herein. It is therefore intended that the disclosure and any following claims be interpreted as covering all such alterations and modifications as fall within the true spirit and scope of the invention, and the invention is not limited by the disclosure herein, but only limited by the appended claims. It is appreciated that certain features of the invention, which are, for clarity, described herein in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention.

What is claimed is:

1. A toothbrush comprising:
a base;
a drive engagement;
one or more toothbrush head, the one or more toothbrush head including one or more brushing surface that can contact at least one normally exposed surface of at least one tooth;
at least one shaft; and
a soft padding substantially encompassing at least one of: the at least one shaft, or the one or more toothbrush head.

2. A toothbrush comprising:
a base;
a drive engagement;
one or more toothbrush head, the one or more toothbrush head including two or more brushing surfaces that can contact at least one normally exposed surface of at least one tooth;
at least one shaft.

3. The toothbrush of claim 2 in which the toothbrush further comprises one or more toothbrush head permanently attached to at least one shaft.

4. The toothbrush of claim 2 in which the toothbrush further comprises one or more brush head and at least one shaft unified in a onepiece construction.

5. The toothbrush of claim 2 in which the toothbrush further comprises one or more brush head detachably mounted to at least one shaft.

6. The toothbrush of claim 2 in which the toothbrush further comprises one or more brush head rotationally coupled to at least one shaft.

7. The toothbrush of claim 2 in which the drive engagement further comprises one or more of: one or more torque converter, one or more gear, one or more drive shaft, one or more cam, one or more tensioning means, one or more retaining means, or one or more interlocking means, configured to convert powered toothbrush brushing motion to upanddown brushing motion.

8. The toothbrush of claim 2 in which the drive engagement further comprises one or more of: one or more torque converter, one or more gear, one or more drive shaft, one or more cam, one or more tensioning means, one or more retaining means, or one or more interlocking means, configured to convert powered toothbrush brushing motion to sidetoside brushing motion.

9. The toothbrush of claim 2 in which the toothbrush further comprises an attached handle.

10. The toothbrush of claim 2 in which the toothbrush further comprises one or more brushing surface disposed with an angled offset to at least one shaft.

11. The toothbrush of claim 2 in which the toothbrush further comprises two or more brushing surfaces secured to separate shafts.

12. The toothbrush of claim 2 in which the one or more brushing surface is reconfigurably adaptable to one or more normally exposed surface of at least one tooth, through a variable interface, the variable interface including one or more adjustment of one or more shaft.

13. The toothbrush of claim 12 in which the variable interface further comprises at least one reconfigurably and retentively bendable shaft, with the bending adjusting the distance, angle, or force between at least one brushing surface and at least one tooth surface.

14. The toothbrush of claim 12 in which the variable interface further comprises at least one shaft whose direction or angle is freely mobile and adjustable, with the adjustment of the direction or angle adjusting the distance, angle, or force between at least one brushing surface and at least one tooth surface.

15. The toothbrush of claim 12 in which the variable interface further comprises at least one shaft whose distance from another shaft is freely mobile and adjustable, with the adjustment of distance adjusting the distance, angle, or force between at least one brushing surface and at least one tooth surface.

16. The toothbrush of claim 12 in which the variable interface further comprises an angle or spacing locking mechanism to adjustably secure one or more shaft into a position.

17. The toothbrush of claim 12 in which the variable interface further comprises one or more tension stabilizer and one or more tension stabilizer attachment point, and in which bristle pressure can be reconfigurably increased or decreased by configuration of one or more tension stabilizer and tension stabilizer attachment point.

18. The toothbrush of claim 12 in which the variable interface further comprises one or more tension stabilizer and one or more tension stabilizer attachment point, and in which bristle pressure can be reconfigurably constrained to at least a minimum bristle pressure by configuration of one or more tension stabilizer and tension stabilizer attachment point.

19. The toothbrush of claim 12 in which the variable interface further comprises one or more tension stabilizer and one or more tension stabilizer attachment point, and in which bristle pressure can be reconfigurably constrained to no more than a maximum bristle pressure by configuration of one or more tension stabilizer and tension stabilizer attachment point.

20. The toothbrush of claim 12 in which the variable interface further comprises one or more tension stabilizer and one or more tension stabilizer attachment point, and in which bristle pressure is automatically adjusted by one or more tension stabilizer as configured with one or more tension stabilizer attachment point.
